(19) United States
(12) Patent Application Publication
(10) Pub. No.: US 2026/0298008 A1
(43) Pub. Date: Oct. 1, 2026

(54) POWERED HINGE FOR VEHICLE TAILGATE

(71) Applicant: Aisin Corporation, Kariya-Shi (JP)

(72) Inventors: Gabrielle A Swider, Ann Arbor, MI (US); Ryan Heins, Wixom, MI (US); Nicholas Edge, New Hudson, MI (US)

(21) Appl. No.: 19/095,485

(22) Filed: Mar. 31, 2025

(51) Int. Cl. E05F 15/622; E05F 15/63

(52) U.S. Cl. CPC E05F 15/622; E05F 15/63; E05Y 2201/408; E05Y 2201/624; E05Y 2201/70; E05Y 2201/702; E05Y 2900/532; E05Y 2900/544

(57) ABSTRACT

A vehicle tailgate assembly with powered tailgate doors is described herein. In one embodiment, a vehicle tailgate assembly includes a frame member pivotally connected to a frame of a vehicle. The frame member selectively pivots about a horizontal axis. The vehicle tailgate assembly also includes a first tailgate door pivotally connected to the frame member. The first tailgate door selectively pivots about a vertical axis. The vehicle tailgate assembly also includes a first powered hinge within the first tailgate door and pivotally coupled to the frame member. The first powered hinge articulates the first tailgate door about the vertical axis. The vehicle tailgate assembly also includes a controller electrically coupled to the first powered hinge. The controller activates the first powered hinge to articulate the first tailgate door.

### TECHNICAL FIELD

The subject matter described herein relates, in general, to vehicle tailgates and, more particularly, to vehicle tailgates with powered doors that can swing out about a vertical axis and swing down about a horizontal axis.

### BACKGROUND

Trucks, which are a type of vehicle, include an open cargo space behind the cabin of the truck. This open cargo space may be referred to as a bed and is defined by sidewalls and a front wall. The front wall may be immediately behind the truck cabin. Both the sidewalls and the front wall rise from a surface that may be referred to as a bed floor.

A tailgate may form the fourth wall of the box-shaped cargo bed. In general, the tailgate pivots upward and downward about a horizontal axis at the base of the tailgate. Specifically, when in a closed or raised position, the contents of the cargo bed may be prevented from sliding out of the bed while the vehicle is moving. The tailgate may be dropped to access the cargo or when loading new cargo into the bed. Thus, the cargo bed resembles a box-like structure, with one box wall pivotable about a horizontal axis. As such, truck beds provide an area to store large cargo or large quantities of cargo, all while providing easy access to load or unload said cargo.

### SUMMARY

In one embodiment, example tailgate assemblies provide one or more tailgate doors that pivot about a horizontal axis, and that also pivot about a vertical axis. The tailgate doors automatically pivot about the horizontal axis via a powered hinge.

In one embodiment, a vehicle tailgate assembly is disclosed. The vehicle tailgate assembly includes a frame member pivotally connected to a frame of a vehicle. The frame member selectively pivots about a horizontal axis. The vehicle tailgate assembly also includes a first tailgate door pivotally connected to the frame member. The first tailgate door selectively pivots about a vertical axis. The vehicle tailgate assembly also includes a first powered hinge within the first tailgate door and pivotally coupled to the frame member. The first powered hinge articulates the first tailgate door about the vertical axis. The vehicle tailgate assembly also includes a controller electrically coupled to the first powered hinge. The controller activates the first powered hinge to articulate the first tailgate door.

In another example, the vehicle tailgate assembly includes a frame member pivotally connected to a frame of a vehicle. The frame member selectively pivots about a horizontal axis. The vehicle tailgate assembly also includes a first tailgate door pivotally connected to the frame member. The first tailgate door selectively pivots about a vertical axis. The vehicle tailgate assembly also includes a first powered hinge within the first tailgate door and pivotally coupled to the frame member. The first powered hinge articulates the first tailgate door about the vertical axis through at least 85 degrees of rotational motion. The vehicle tailgate assembly also includes a controller electrically coupled to the first powered hinge. The controller activates the first powered hinge to articulate the first tailgate door.

In another example, the vehicle tailgate assembly includes a frame member pivotally connected to a frame of a vehicle. The frame member selectively pivots about a horizontal axis. The vehicle tailgate assembly also includes a first tailgate door pivotally connected to the frame member. The first tailgate door selectively pivots about a vertical axis. The vehicle tailgate assembly also includes a first powered hinge within the first tailgate door and pivotally coupled to the frame member. The first powered hinge articulates the first tailgate door about the vertical axis. The first powered hinge includes 1) a motor assembly and 2) a drive assembly coupled to the motor assembly. The first powered hinge also includes a check arm translated by the drive assembly. Translation of the check arm articulates the first tailgate door about the vertical axis. The vehicle tailgate assembly also includes a controller electrically coupled to the first powered hinge. The controller activates the first powered hinge to articulate the first tailgate door.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle tailgate assembly with two tailgate doors, driven by powered hinges, in a closed position.

FIG. 2 is an assembled view of a powered hinge to articulate a tailgate door of a vehicle tailgate assembly.

FIG. 3 is an exploded view of a powered hinge to articulate a tailgate door of a vehicle tailgate assembly.

FIG. 4 illustrates one embodiment of a vehicle tailgate assembly with two tailgate doors, driven by powered hinges, in an opened position.position.

FIG. 5 illustrates one embodiment of a vehicle tailgate assembly with two tailgate doors in a dropped position.

FIG. 6 illustrates one embodiment of a vehicle tailgate assembly with two tailgate doors, one driven by a powered hinge, in a closed position.

FIG. 7 illustrates one embodiment of a vehicle tailgate assembly with a width-wide tailgate door, driven by a powered hinge, in a closed position.

FIG. 8 illustrates one embodiment of a vehicle tailgate assembly with a width-wide tailgate door, driven by a powered hinge, in an opened position.

FIG. 9 illustrates one embodiment of a vehicle tailgate assembly with a width-wide tailgate door in a dropped

### DETAILED DESCRIPTION

Devices associated with improving vehicle cargo bed accessibility are disclosed herein. As previously described, trucks include an open cargo space behind the cabin of the truck. This open cargo space may be referred to as a bed and is defined by sidewalls and a front wall. A pivotable tailgate forms the fourth wall of the box-shaped cargo bed. In general, the tailgate pivots upward and downward about a horizontal axis at the base of the tailgate. When raised, the tailgate prevents the cargo from being dislodged from the cargo bed. To access the cargo bed (e.g., to load or unload cargo), the tailgate may be pivoted about a horizontal axis to an opened or lowered position. As such, truck beds provide an area to store large cargo or large quantities of cargo while providing easy access to load or unload said cargo.

While tailgates undoubtedly provide great utility due to their increased carrying capacity and ability to provide quick and easy access to the contents of the truck bed (i.e., a pivotable tailgate), additional developments may enhance their ease of use and utility. For example, a lowered tailgate increases the distance between the user and the cargo in the bed. This may make certain cargo, especially cargo further back in the cargo bed, difficult to reach. Moreover, a lowered tailgate may eliminate the ability of a user to use a vehicle bumper as a step to get into or out of the cargo bed.

Also, tailgate doors may be heavy and cumbersome to manipulate. Moreover, it may be that a user is carrying an object and, therefore, cannot manually open the tailgate without dropping the object. In either of these cases, it may be difficult and/or inconvenient for a user to manually extend the tailgate door panels.

Accordingly, the present specification describes a vehicle tailgate assembly where the tailgate door(s) can swing outward about a vertical axis and downward about a horizontal axis. The outward movement about the vertical axis is driven by a powered hinge that automatically opens and shuts the tailgate door, facilitating the remote operation of the tailgate doors and enabling a less physically demanding operation of the tailgate doors. In one particular example, the tailgate assembly includes two tailgate doors, each of which is articulated about a vertical axis by a powered hinge. The powered hinges are disposed within respective tailgate doors and may be activated by a controller. The controller may receive user input via switches on the tailgate doors themselves (e.g., in the handles of the tailgate doors) or from a remote-control system as may be found in a key fob.

More specifically, the vehicle tailgate assembly includes a frame member that is disposed around the edges of the tailgate door. Specifically, a first vertical portion of the frame member is disposed between a first sidewall of the truck bed and an outside edge of a first tailgate door. A second vertical portion of the frame member is disposed between a second sidewall of the truck bed and an outside edge of a second tailgate door. A horizontal portion of the frame member joins the bases of the respective vertical portions and sits between the floor of the truck bed and the bottom edges of both tailgate doors. In this example, the frame member is a U-shaped structure.

The frame member pivots about a horizontal axis relative to the vehicle frame. The frame member, and the attached tailgate door(s), are selectively prevented from pivoting about the horizontal axis via frame latches. Each tailgate door is attached to the frame member via a hinge and can pivot about a respective vertical axis. The tailgate door(s) are selectively prevented from pivoting about the vertical axis via a door latch.

A powered hinge controls the movement of a respective tailgate door. In the case of a tailgate assembly with split tailgate doors, the tailgate assembly includes two powered hinges, one per tailgate door. The powered hinges are rigidly mounted on the inside of the respective tailgate door (e.g., between a bed-facing panel of the tailgate door and an environment-facing panel of the tailgate door). One end of a check arm of the powered hinge is pivotally connected to the frame member. The powered hinge operates to extend the check arms from the powered hinge. Extension of the check arm presses against the frame member. Given that the frame member is in a fixed location, an extension of the check arm articulates the respective tailgate door, which is moveable, about a vertical axis. In an example, the powered hinge and check arm may be structured to articulate the tailgate door through at least 85 degrees of rotational motion and, in some cases, through more than 90 degrees of rotational motion. As described in more detail below, the tailgate assembly includes other components that facilitate the dual motion (i.e., swinging outward about a vertical axis and swinging downward about a horizontal axis) of the tailgate door(s).

Split tailgate doors that swing about a vertical axis may provide easier entry into the truck bed, provide easier access to the cargo therein, and avoid the obstruction of a bumper step caused by a lowered tailgate. As such, a user may not need to reach over a lowered tailgate to access cargo within the tailgate. Moreover, the powered hinge provides hands-free automatic articulation of vehicle tailgate doors about one axis (i.e., a vertical axis).

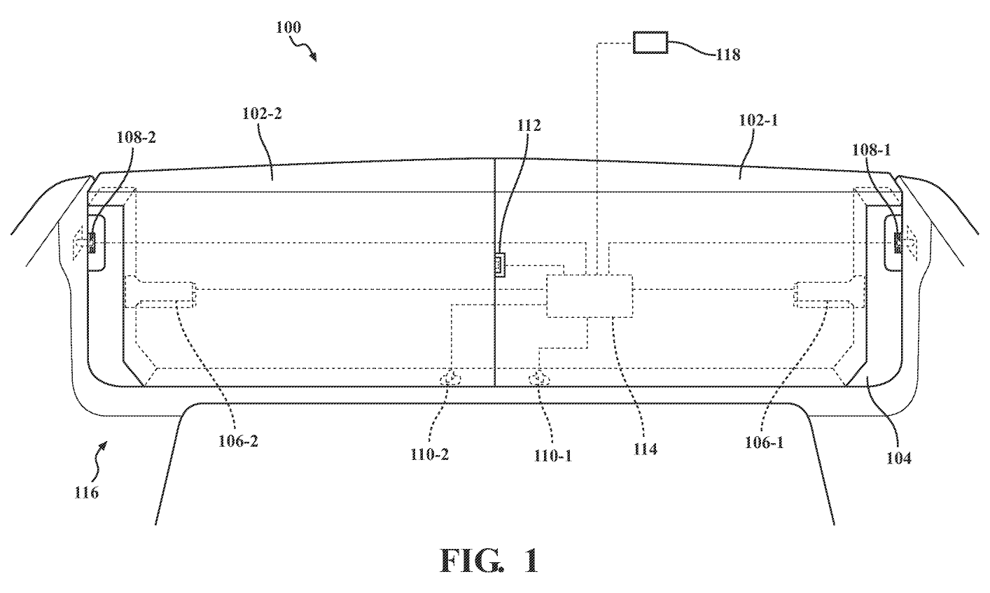

Turning now to the figures, FIG. 1 illustrates one embodiment of a vehicle tailgate assembly 100 with two tailgate doors 102-1 and 102-2, driven by powered hinges 106-1 and 106-2, in a closed position. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle tailgate assembly 100 includes a powered hinge 106 that is implemented to improve vehicle tailgate operation. In an example, the presence of a “-*” reference number may specify a specific instance of a component while the absence of such an indicator refers to a general instance of the component.

In this description, uses of “front,” “forward,” and the like, and uses of “rear,” “rearward,” and the like, refer to the longitudinal directions of the vehicle. “Front,” “forward,” and the like refer to the front (fore) of the vehicle, while “rear,” “rearward,” and the like refer to the back (aft) of the vehicle. Uses of “side,” “sideways,” “transverse,” and the like refer to the lateral directions of the vehicle. Uses of “above,” “below,” and the like refer to the vertical directions of the vehicle.

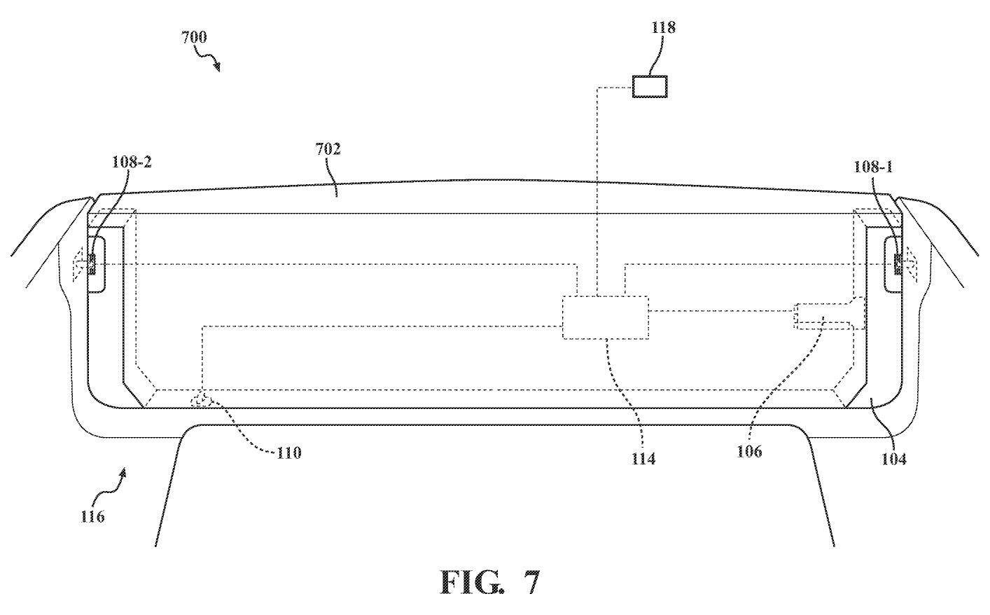

Returning to the figures, in the example depicted in FIG. 1, the vehicle tailgate assembly 100 is a split-tailgate system with multiple tailgate doors 102-1 and 102-2. Specifically, the vehicle tailgate assembly 100 includes a first tailgate door 102-1 that extends across a first portion of a width of an opening of a truck bed 116. The vehicle tailgate assembly 100 also includes a second tailgate door 102-2. A combined width of the first tailgate door 102-1 and the second tailgate door 102-2 spans a width of the opening of the truck bed 116. In other examples, such as that depicted in FIGS. 7-9, the vehicle tailgate assembly 100 may include a single width-wide tailgate door.

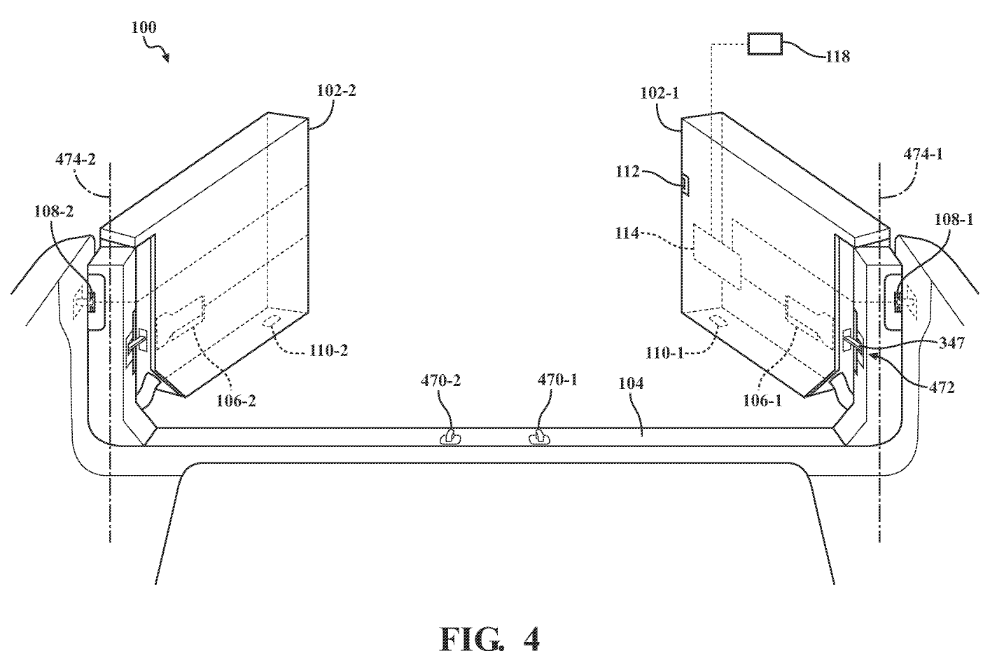

As depicted in FIG. 4, the tailgate doors 102-1 and 102-2 may pivot about respective vertical axes. However, the tailgate doors 102-1 and 102-2, rather than being hingedly connected to the frame of the vehicle, may be hingedly attached to a frame member 104. In general, the frame member 104 is a rigid component that sits between the tailgate doors 102-1 and 102-2 and the frame of the vehicle. The frame member 104 may include a 1) horizontal portion that is below the tailgate doors 102-1 and 102-2 and between the tailgate doors 102-1 and 102-2 and a bed of the frame of the vehicle and 2) vertical portions that are to the side of each respective tailgate door 102-1 and 102-2 and between the respective tailgate door 102-1 and 102-2 and an adjacent vertical sidewall of the truck bed 116. That is, the frame member 104 may be U-shaped.

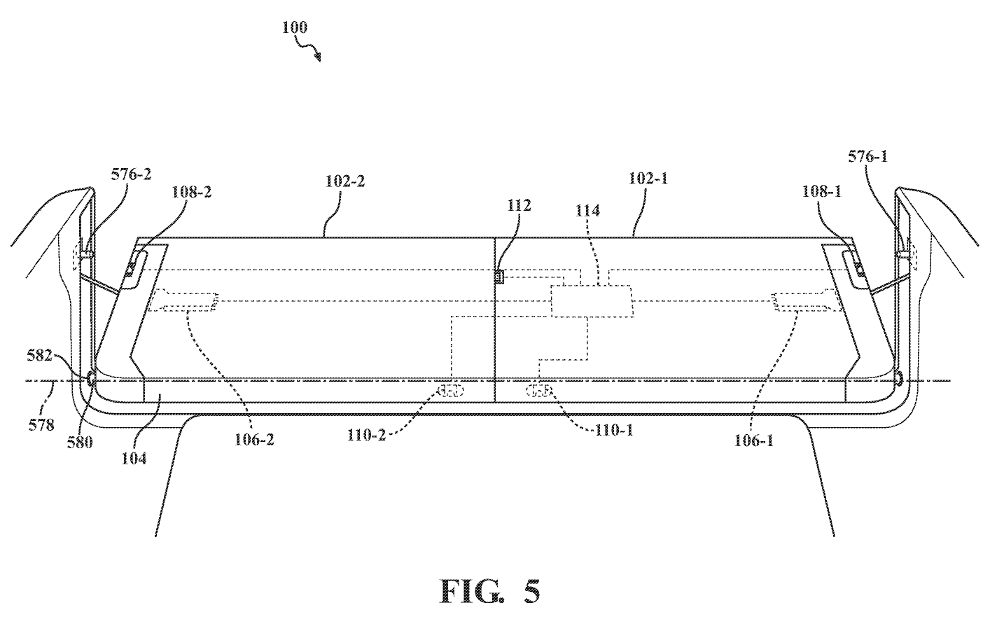

The portions of the frame member 104 that are to the side of the tailgate doors 102-1 and 102-2 (i.e., the vertical portions of the frame member 104) may include frame latches 108-1 and 108-2 that interact with pins on the vehicle frame to prevent the frame member 104 and tailgate doors 102-1 and 102-2 from pivoting about the horizontal axis. That is, the frame member 104 may selectively pivot about a horizontal axis, as depicted in FIG. 5. Additional details regarding the pivoted connection between the frame member 104 and the frame of the vehicle are provided below in connection with FIG. 5.

During some uses, for example, when the tailgate doors 102-1 and 102-2 are to be swung out about vertical axes as depicted in FIG. 4, the frame member 104 may be affixed to the frame of the vehicle via respective frame latches 108-1 and 108-2. That is, the vehicle tailgate assembly 100 may include a first frame latch 108-1 and a second frame latch 108-2 to selectively prevent the frame member 104 from rotating relative to the frame of the vehicle.

The frame latches 108-1 and 108-2 may take various forms. For example, as depicted in FIG. 5, posts may extend inward from either sidewall of the truck bed 116. The frame latches 108-1 and 108-2 may be structured to selectively release from these posts. For example, the frame latches 108-1 and 108-2 may include a hooked latch. When engaged, the hooked latches wrap around at least a portion of the respective post and prevent the frame member 104 from pivoting about a horizontal axis. Upon activating an actuator (i.e., activation of a switch 118), the hooked latches rotate and are released from the respective post such that the frame member 104, and mounted tailgate doors 102-1 and 102-2, may rotate downward about the horizontal axis. That is, when engaged, the frame latches 108-1 and 108-2 prevent the frame member 104 from rotating about the horizontal axis, and when disengaged, the frame latches 108-1 and 108-2 allow the frame member 104 to rotate about the horizontal axis. FIG. 4 below depicts frame latches 108-1 and 108-2 engaged with the vehicle frame pins, and FIG. 5 below depicts frame latches 108-1 and 108-2 disengaged from the vehicle frame pins. In one example, the frame latches 108-1 and 108-2 are electromechanical latches that are activated by the controller 114 based on input received from at least one switch 118.

The portion of the frame member 104 that is below the tailgate doors 102-1 and 102-2 (i.e., the horizontal portion of the frame member 104) may include strike plates that interact with the door latches 110-1 and 110-2 on the respective tailgate doors 102-1 and 102-2 to prevent the tailgate doors 102-1 and 102-2 from pivoting about the vertical axis. That is, each tailgate door 102-1 and 102-2 may selectively pivot about a respective vertical axis as depicted in FIG. 4, with the first tailgate door 102-1 pivoting about a first vertical axis and the second tailgate door 102-2 pivoting about a second vertical axis. That is, vertical portions of the frame member 104 may include hinges that allow rotational movement of the respective tailgate door 102-1 and 102-2 about a respective vertical axis. Additional details regarding the pivoted connection between the tailgate doors 102-1 and 102-2 and the frame member 104 are provided below in connection with FIG. 4.

During some uses, for example, when the tailgate doors 102-1 and 102-2 are to be swung downward about a horizontal axis as depicted in FIG. 5, the tailgate doors 102-1 and 102-2 may be affixed to the frame member 104 via respective door latches 110-1 and 110-2. That is, the vehicle tailgate assembly 100 may include a first door latch 110-1 and a second door latch 110-2 to selectively prevent the first tailgate door 102-1 and the second tailgate door 102-2, respectively, from rotating relative to the frame member 104.

The door latches 110-1 and 110-2 may take various forms. For example, as depicted in FIG. 4, the frame member 104 may include posts extending upward from a horizontal portion of the frame member 104. The door latches 110-1 and 110-2 may be structured to selectively release from these posts. For example, the door latches 110-1 and 110-2 may include hooked latches. When engaged, the hooked latches wrap around at least a portion of the respective post and prevent the respective tailgate doors 102-1 and 102-2 from rotating about respective vertical axes. Upon activating an actuator (i.e., activation of a switch 118), the hooked latches rotate and are released from the respective posts such that the respective tailgate doors 102-1 and 102-2 may rotate outward about respective vertical axes. That is, when engaged, the door latches 110-1 and 110-2 prevent the respective tailgate doors 102-1 and 102-2 from rotating about respective vertical axes, and when disengaged, the door latches 110-1 and 110-2 allow the respective tailgate doors 102-1 and 102-2 to rotate about respective vertical axes. FIG. 4 below depicts door latches 110-1 and 110-2 disengaged from the frame member strike plates, and FIG. 5 below depicts door latches 110-1 and 110-2 engaged with frame member strike plates. In one example, the door latches 110-1 and 110-2 are electromechanical latches that are activated by the controller 114 based on input received from at least one switch 118.

This system of latches (i.e., door frame latches 108-1 and 108-2, door latches 110-1 and 110-2, and the inter-door latch 112) facilitates the dual-axis motion of the tailgate doors 102-1 and 102-2.

As described above, the tailgate doors 102-1 and 102-2 may be heavy and cumbersome to swing open about the vertical axes. Moreover, a user’s hands/arms may not be free to physically manipulate the tailgate doors 102-1 and 102-2 as may occur, for example, when carrying cargo to load into the truck bed 116. Accordingly, in this example, the vehicle tailgate assembly 100 includes a powered hinge 106-1 and 106-2 per tailgate door 102-1 and 102-2 to articulate the respective tailgate door 102-1 and 102-2 about the respective vertical axis. Specifically, in the example depicted in FIG. 1, the vehicle tailgate assembly 100 includes 1) a first powered hinge 106-1 that articulates the first tailgate door 102-1 about a first vertical axis and 2) a second powered hinge 106-2 that articulates the second tailgate door 102-2 about a second vertical axis.

Specifically, the first powered hinge 106-1 is mounted within (i.e., between an outside environment-facing surface and an inside bed-facing surface) of the first tailgate door 102-1 and is pivotally connected to the frame member 104. The first powered hinge 106-1 articulates the first tailgate door 102-1 about a first vertical axis. Similarly, the second powered hinge 106-2 is mounted within (i.e., between an outside environment-facing surface and an inside bed-facing surface) of the second tailgate door 102-2 and is pivotally connected to the frame member 104. The second powered hinge 106-2 articulates the second tailgate door 102-2 about a second vertical axis.

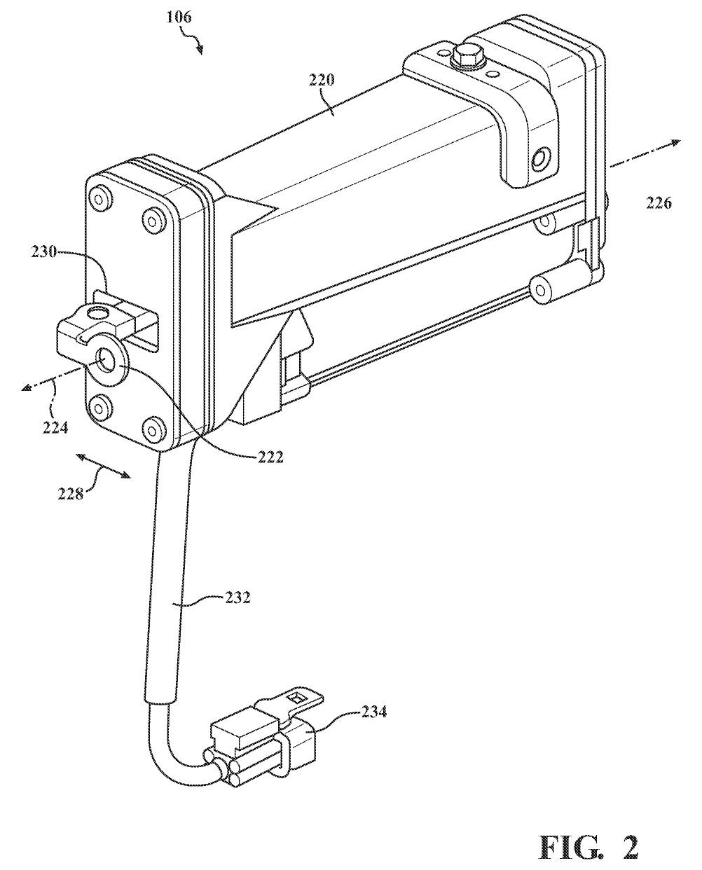

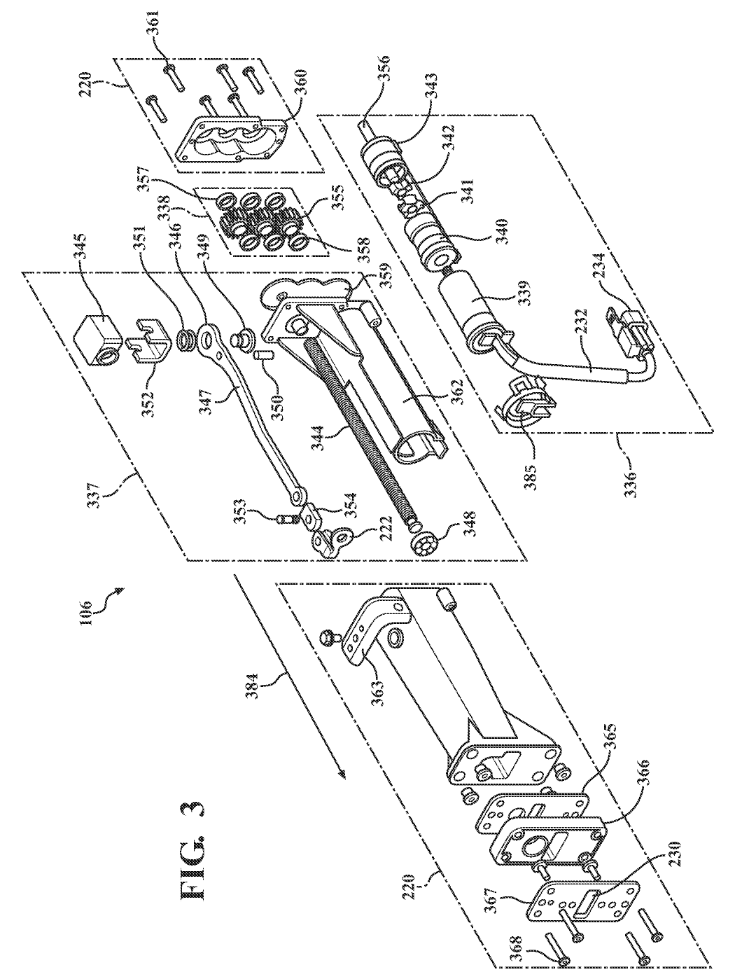

In general, the powered hinges 106-1 and 106-2 include a motor assembly within a housing. The motor assembly operates to extend a check arm. An end of the check arm that is within the housing is rigidly mounted within a respective tailgate door 102-1 and 102-2 (which is movable when the associated door latch 110-1 and 110-2 is disengaged) and the other end is pivotally coupled to the frame member 104 (which is immovable when the frame latches 108-1 and 108-2 are engaged). As the check arms extend, they press against the frame member 104. However, given that 1) the frame member 104 is immovable in the direction of force of the check arm against the frame member 104 and 2) the tailgate doors 102-1 and 102-2 are free to rotate, this force causes the tailgate doors 102-1 and 102-2 to rotate outwards about the respective vertical axes. Additional details regarding the structure of the powered hinges 106-1 and 106-2 are provided below in connection with FIGS. 2 and 3.

In an example, the split tailgate doors 102-1 and 102-2 may be coupled together. For example, it may be desirable to lower both tailgate doors 102-1 and 102-2 about the horizontal axis. To facilitate this coordinated movement, the first tailgate door 102-1 may include an inter-door latch 112 that selectively couples the first tailgate door 102-1 and the second tailgate door 102-2 together.

The inter-door latch 112 may take a variety of forms. For example, the second tailgate door 102-2 may include a post extending inward from a first door-facing sidewall. The inter-door latch 112 on the first tailgate door 102-1 may be structured to selectively release from this post. For example, the inter-door latch 112 may include a hooked latch. When engaged, the hooked latch wraps around at least a portion of the respective post and prevents the independent movement of the first tailgate door 102-1 and the second tailgate door 102-2. Upon activating an actuator (i.e., activation of a switch 118), the hooked latch rotates and is released from the respective post such that the respective tailgate doors 102-1 and 102-2 may independently rotate. That is, when engaged, the inter-door latch 112 prevents the tailgate doors 102-1 and 102-2 from rotating about respective vertical axes and couples the tailgate doors 102-1 and 102-2 to move together. When disengaged, the inter-door latch 112 allows the tailgate doors 102-1 and 102-2 to rotate about respective vertical axes. FIG. 4 depicts a disengaged inter-door latch 112 and FIG. 5 depicts an engaged inter-door latch 112. In one example, the inter-door latch 112 is an electromechanical latch that is activated by the controller 114 based on input received from at least one switch 118.

As described, the components depicted in FIG. 1, such as the first powered hinge 106-1, the second powered hinge 106-2, the first frame latch 108-1, the second frame latch 108-2, the first door latch 110-1, the second door latch 110-2, and the inter-door latch 112 may be electromechanical latches, meaning that these components are activated via an electronic control signal, which is provided by the controller 114. The controller 114 may include a processor and memory that transmits control signals to at least the first powered hinge 106-1 to articulate the first tailgate door 102-1 and the second powered hinge 106-2 to articulate the second tailgate door 102-2. The input to the controller 114 may come from a switch 118. That is, the controller 114 controls each of these components based on user input.

Accordingly, the vehicle tailgate assembly 100 may include at least one switch 118, which may be within the first tailgate door 102-1. The at least one switch 118 controls the operation of at least one of the first powered hinge 106-1, the second powered hinge 106-2, the first frame latch 108-1, the second frame latch 108-2, the first door latch 110-1, the second door latch 110-2, and the inter-door latch 112. The form of the at least one switch 118 may vary. For example, the switch 118 may be a touchpad on the exterior handles of the first tailgate door 102-1.

Activation of the powered hinges 106-1 and 106-2 and the movement of the respective tailgate doors 102-1 and 102-2 about the respective vertical axes may be controlled by a controller 114. The switch 118 may take a variety of forms. For example, the switch 118 may be a single-pole switch that selectively opens or closes a circuit. For example, when the switch 118 is in a state to close a circuit, a signal may be transmitted to the controller 114 to articulate one or more of the tailgate doors 102-1 and 102-2. By comparison, no signal is transmitted when the switch 118 is in a state where the circuit is open. In another example, the switch 118 may be a capacitive sensor that senses a change in capacitance, which may occur when an operator’s finger contacts the sensor. In this example, a user contacting the capacitive sensor may generate a control signal to the controller 114 to articulate one or more tailgate doors 102-1 and 102-2. By comparison, no signal is transmitted when the user is not contacting the capacitive sensor. While particular reference is made to particular switches 118, other types of switches may be implemented in accordance with the principles described herein, including pressure switches that are activated via pressure force and piezo-electric switches. While FIG. 1 and others depict a single switch 118, in an example, the controller 114 may receive input from different switches 118, each of which may trigger different articulations of the first tailgate door 102-1 and the second tailgate door 102-2.

The switches 118 may be integrated with either the first tailgate door 102-1 and/or the second tailgate door 102-2. In this example, the controller 114 may be wirelessly connected or connected by wire to the switch 118 such that when a user operates a particular switch 118, a corresponding tailgate door 102-1 and 102-2 opens or closes. In an example, the controller 114 may wirelessly communicate with a switch 118 on a key fob. That is, a key fob may have single-pole switches, capacitive sensors, or other types of switches that an operator can actuate to initialize certain tailgate operations (e.g., open a first tailgate door 102-1, open a second tailgate door 102-2, open both tailgate doors, drop connected tailgate doors, etc.).

FIG. 2 is an assembled view of a powered hinge 106 to articulate a tailgate door 102 of a vehicle tailgate assembly 100. As described above, the powered hinge 106 generally includes a motor assembly that drives a check arm to press against an immovable surface (i.e., the frame member 104), which causes the movable tailgate door 102 to pivot about a vertical axis.

In general, the powered hinge 106 includes a housing 220 that encases the components (e.g., motor assembly, drive assembly, gear assembly, and brake assembly, among others) that operate to extend the check arm. As described and depicted above, the housing 220 is attached to and positioned inside the respective tailgate door 102-1 and 102-2. A frame end (i.e., the second end 222) of the check arm is pivotally mounted to the frame member 104 and is extendable away from the respective housing 220 in a direction indicated by the arrow 224. On account of the frame member 104 being immovable in the direction of the extension of the check arm (i.e., the direction indicated by the arrow 224), as the check arm extends from the housing 220, the effect is that a force is exerted on the housing 220 in a direction indicated by the arrow 226. However, this force is converted into a pivoting movement based on the hinged attachment of the tailgate door 102 (in which the powered hinge 106 is installed) and the frame member 104.

During the rotation of the powered hinge 106 and respective tailgate door 102 about the vertical axis, the check arm may exhibit lateral movement in the direction indicated by the arrow 228. Accordingly, the housing 220 may include an opening 230 that facilitates this translational movement. The dimensions of the opening 230 may be defined by the operational characteristics of the vehicle tailgate assembly 100 (i.e., size and dimensions of the tailgate doors 102-1 and 102-2 and the range of rotation of the tailgate doors 102-1 and 102-2 to name a few). That is, as the tailgate doors 102-1 and 102-2 may have a range of motion of greater than 85 degrees and, in some cases, greater than 90 degrees, the opening 230 in a housing 220 may be sized to facilitate ranges of door rotation that are greater than 85 degrees and in some examples greater than 90 degrees.

In an example, the powered hinge 106 may be powered by the vehicle. Accordingly, the powered hinge 106 may include an electrical harness 234 that is received into a corresponding electrical harness of the vehicle. Via this electrical connection, an electrical current is provided via a cable 232 to the motor assembly of the powered hinge 106 to extend the check arm and articulate the respective tailgate door 102-1 and 102-2.

FIG. 3 is an exploded view of a powered hinge 106 to articulate a tailgate door 102-1 and 102-2 of a vehicle tailgate assembly 100. In general, the powered hinge 106 includes a motor assembly 336, a drive assembly 337, a gear assembly 338, and the housing 220. Each will be described in turn.

In general, the motor assembly 336 includes multiple components that operate to extend and retract the check arm 347, as indicated in FIG. 2. The motor assembly 336 may include the previously described electrical harness 234 and cable 232, through which power is provided to the motor 339. In general, the motor 339 converts electrical energy, in some examples supplied by the vehicle, into mechanical energy (i.e., rotation of a threaded spindle 344). The motor 339 may be an electromagnetic motor that generates a magnetic field when electric current flows through wire coils. The current in the wire coils generates a magnetic field, which causes a motor shaft 356 to turn.

In an example, the motor 339 of the motor assembly 336 is operated at a rotational speed of between 4900 and 5100 rotations per minute (RPM). This operating range may be particularly suited for a powered hinge 106 used in a tailgate door 102. For example, multiple latches may hold the tailgate door 102 closed. Operating the motor 339 at this particular speed ensures proper seating and unseating of the tailgate door 102 in these tailgate-specific safety latches. In some examples, the motor 339 may be operated at a lower speed when the respective tailgate door 102 is approaching a nearly closed state. For example, when the tailgate door 102 is 90 % closed, the rotational speed of the motor 339 may be reduced to slow the speed of door closure, which may prevent injury (e.g., pinched fingers that could result from sudden door closure).

The motor assembly 336 may include other components such as an output sun gear, a motor gearbox 340 that provides a first gear reduction for the motor assembly 336, and a motor seal 385 that compresses a harness seal against the motor 339. The motor assembly 336 may further include a cushion 341 that absorbs noise and inputs between the brake assembly 343 and the gearbox 340.

The powered hinge 106 also includes a drive assembly 337 that converts the rotational motion of the motor 339 into a translational movement of the check arm 347. As such, the drive assembly 337 may be coupled to the motor assembly 336.

In general, the drive assembly 337 includes a threaded spindle 344 rotated by the motor 339 of the motor assembly 336. That is, the rotational motion of the motor 339 is converted to rotational motion at the threaded spindle 344. As depicted in FIG. 3, the threaded spindle 344 may include threads along its length. These threads of the threaded spindle 344 interact with threads on a threaded nut 345 to generate a translational force and motion.

The drive assembly 337 also includes a threaded nut 345 that surrounds and is coaxial to the threaded spindle 344. As described above, the threaded nut 345 includes threads that interact with the threads of the threaded spindle 344. Due to the interface of these threads, the threaded nut 345 translates along the threaded spindle 344 as the threaded spindle 344 rotates. The direction of translation depends on the direction of rotation of the threaded spindle 344. For example, as the threaded spindle 344 is rotated in one direction (e.g., clockwise), the threaded nut 345 may translate in a direction indicated by the arrow 384. This movement may cause the check arm 347, which is coupled to the threaded nut 345, to also translate in the direction indicated by the arrow 384. This may cause the frame end (i.e., the second end 222) of the check arm 347 to press against the frame member 104 to swing the respective tailgate door 102 open about the respective vertical axis.

By comparison, as the threaded spindle 344 is rotated in the opposite direction (e.g., counter-clockwise), the threaded nut 345 may translate in a direction opposite the direction indicated by the arrow 384. This movement may cause the check arm 347, which is coupled to the threaded nut 345, to also translate in a direction opposite the direction indicated by the arrow 384. This may cause the frame end (i.e., the second end 222) of the check arm 347 to pull against the frame member 104 to swing the respective tailgate door 102 closed about the respective vertical axis.

As described above, the check arm 347 is 1) pivotally connected at a first end 346 to the threaded nut 345 and 2) pivotally connected at a second end 222 to the frame member 104. These pivotable connections facilitate any lateral movement of the check arm 347 as the respective tailgate door 102-1 and 102-2 rotates about the respective vertical axis.

As with the motor assembly 336, the drive assembly 337 may include other components to facilitate the movement of the drive assembly 337. For example, the drive assembly 337 may include a spindle bearing 348 for the threaded spindle 344 to connect to a support bracket 366, a mechanical stop pin 350 for the check arm 347 at full open, a check bracket 349 to connect the threaded nut 345 to the check arm 347 (which also serves as a pivot of the check arm 347), a check arm bushing 351 to facilitate the threaded nut 345 and check arm 347 pivot, and a nut case 352 to facilitate attachment of the threaded nut 345 to the check arm 347.

As described above, the check arm 347 includes a frame end (i.e., a second end 222) that connects to the frame member 104 and that transmits the output thrust from the check arm 347 to the frame member 104. The frame end of the check arm 347 may include an over-molded end fitting 354, which acts as a bushing, and a door check pin 353 that connects the second end 222 to the check arm 347 and acts as a pivot between the check arm 347 and the second end 222. The second end 222 may be attached to the frame member 104 in various ways, including a bolt inserted through an aperture in the second end 222 to engage with a threaded hole on the frame member 104.

In an example, the powered hinge 106 further includes a gear assembly 338 that transfers power from the motor assembly 336 to the drive assembly 337. In some examples, such as that depicted in FIG. 3, the plane of the motor assembly 336 may differ from that of the drive assembly 337. Accordingly, in this example, the gear assembly 338 may change the plane of the output of the motor assembly 336. Specifically, the gear assembly 338 may include multiple gears 355, the first of which is coupled to a motor shaft 356 driven by the motor 339 and the last of which is coupled to the threaded spindle 344. As noted, the gears 355 of the gear assembly 338 transmit the rotation from the motor 339 axis to the threaded spindle 344 axis. The gear assembly 338 may include other components, such as a set of bushings 357 and 358 on either side of each gear 355. The bushings 357 and 358 ensure proper alignment of the gears 355.

In an example, the powered hinge 106 includes a brake assembly 343 to selectively lock the threaded spindle 344, the threaded nut 345, the check arm 347, and the respective tailgate door 102-1 and 102-2 in place. For example, it may be desirable to retain the tailgate door 102 in a partially opened position. As a specific example, a vehicle sensor may detect that an object, such as a person or cargo, occupies the path the tailgate door 102 would follow during closure. To prevent injury to the person or damage to the cargo, the brake assembly 343 may halt the motion of the check arm 347 so that the tailgate door 102 does not open or shut further. In another example, the command to interrupt the operation of the powered hinge 106 and movement of the tailgate door 102 may be based on a user command, such as from one of the switches 118 or a button on a key fob. In either case, the brake assembly 343, in general, stops the rotation of the motor shaft 356 by applying a resistance against the movement.

In an example, the brake assembly 343 is an electromagnetic brake assembly. The electromagnetic brake assembly may include coils of wire. As current is passed to the brake assembly 343, a disc brake is magnetically drawn toward another disc brake. In other words, the electromagnetic brake assembly 343 includes two friction surfaces that are drawn together using electromagnetic force. In an example, the electromagnetic force is generated by introducing an electrical current to the coils of wire. In this example, the powered hinge 106 may include a coupler 342 that connects the gearbox 340 to the brake assembly 343. Note that while particular reference is made to a particular example of a brake assembly 343, the brake assembly 343 may be of different types to stop the rotational movement of the motor shaft 356.

FIG. 3 also depicts various components of the housing 220, including a door seal 359 that seals an interface between a rear door 360 and a motor assembly housing 362. The rear door 360 is a housing and cover for the gears 355. The rear door 360 is attached to the motor assembly housing 359 via a number of fasteners 361 such as screws.

The housing 220 also includes a door bracket 363, which affixes the powered hinge 106 to the respective tailgate door 102-1 and 102-2 via any number of fasteners such as screws. The housing 220 also includes a pair of support brackets 365 and 366 that align the threaded spindle 344 and provide structural support. The housing 220 may further include a front door 367 through which the powered hinge 106 is coupled to the respective tailgate door 102-1 and 102-2 via a number of fasteners 368 such as bolts.

FIG. 4 illustrates one embodiment of a vehicle tailgate assembly 100 with two tailgate doors 102-1 and 102-2, driven by powered hinges 106-1 and 106-2, in an opened position. As described above, tailgate doors 102-1 and 102-2, as compared to other vehicle doors, pose certain complications for automated opening. For example, tailgate doors 102-1 and 102-2 may have a wider range of motion than passenger doors. Specifically, tailgate doors 102-1 and 102-2 may have ranges of motion greater than 85 or 90 degrees. As such, the powered hinges 106-1 and 106-2 are structured to articulate the first tailgate door 102-1 and the second tailgate door 102-2 through at least 85, and in some cases, greater than 90 degrees of rotational motion. This range of motion is accommodated by increasing the width of the opening 230 in the housing 220 of the powered hinge 106.

As described above, in some examples, the vehicle tailgate assembly 100 may include multiple tailgate doors 102-1 and 102-2 where a combined width of the tailgate doors 102-1 and 102-2 span a width of the opening of a truck bed 116. In this example, each tailgate door 102-1 and 102-2 may include a powered hinge 106-1 and 106-2. As described above, each tailgate door 102-1 and 102-2 may articulate about a respective vertical axis 474-1 and 474-2 and is attached to the frame member 104 via a hinge 472. For simplicity, a single hinge 472 is depicted in FIG. 4. However, a similar hinge may attach the second tailgate door 102-2 to the frame member 104. Via this hinged attachment, the tailgate doors 102-1 and 102-2 may independently rotate about respective vertical axes 474-1 and 474-2 between a closed position, as depicted in FIG. 1, and an open position, as depicted in FIG. 4.

As described above, a second end 222 of the check arm 347 may be affixed to the frame member 104. As such, as the check arm 347 is extended outside the housing 220 as described above, the second end 222 pushes against the frame member 104. However, the frame member 104 is stationary in the direction of the extension of the check arm 347. Accordingly, the tailgate doors 102-1 and 102-2, which are not fixed, rotate outwards, as depicted in FIG. 4.

FIG. 4 also depicts the arrangement of various other components of the vehicle tailgate assembly 100. Specifically, FIG. 4 depicts the strike plates 470-1 and 470-2 that interact with respective door latches 110-1 and 110-2 to either allow or prevent rotation of the respective tailgate doors 102-1 and 102-2 about the respective vertical axes 474-1 and 474-2. As depicted in FIG. 4, the door latches 110-1 and 110-2 are disengaged, so the tailgate doors 102 may swing open about the respective vertical axes 474-1 and 474-2.

Also as depicted in FIG. 4, the electromechanical frame latches 108-1 and 108-2 on the frame member 104 are engaged with associated posts on the vehicle frame. In this arrangement, the frame member 104 and mounted tailgate doors 102-1 and 102-2 are prevented from rotating about the horizontal axis depicted in FIG. 5.

As described above, a user may actuate switches 118 to open either tailgate door 102. As described above, the switches 118 may be of various types, including a single-pole mechanical switch, a capacitive switch, a pressure switch, or a piezoelectric switch, and may be integrated on either the tailgate doors 102-1 and 102-2 or a key fob. In either case, responsive to a receipt of a command from the switch 118, the controller 114 may activate the frame latches 108-1 and 108-2, deactivate the door latches 110-1 and 110-2, deactivate the inter-door latch 112, and activate the powered hinges 106-1 and 106-2 to facilitate the opening and closing of the tailgate doors 102-1 and 102-2 about the respective vertical axes 474-1 and 474-2.

FIG. 5 illustrates one embodiment of a vehicle tailgate assembly 100 with two tailgate doors 102-1 and 102-2 in a dropped position. In addition to swinging open about vertical axes 474-1 and 474-2, the tailgate doors 102-1 and 102-2 may pivot about a horizontal axis 578 as depicted in FIG. 5. Specifically, the frame member 104, and the attached tailgate doors 102-1 and 102-2, may articulate about the horizontal axis 578. To facilitate this downward pivot motion, the frame member 104 may be attached to the frame of the vehicle in various ways. For example, the frame member 104 may include a protrusion 580 on either lateral side. This protrusion 580 fits within a socket 582 on the vertical sidewall of the truck bed 116. For simplicity, the protrusion/socket connection on one side of the frame member 104 is identified with reference numbers. However, a similar arrangement may be found on the other side of the frame member 104. This connection facilitates rotation of the frame member 104 about the horizontal axis 578, which is defined by the axis of the protrusion 580 and socket 582. That is, via this hinged attachment, the frame member 104 may rotate about the horizontal axis 578 between a closed position, as depicted in FIG. 1, and an open position, as depicted in FIG. 5.

FIG. 5 also depicts the arrangement of various other components of the vehicle tailgate assembly 100 to facilitate the pivoting about the horizontal axis 578. Specifically, FIG. 5 depicts the rods 576-1 and 576-2 that interact with respective frame latches 108-1 and 108-2 to either allow or prevent rotation of the frame member 104 about the horizontal axis 578. As depicted in FIG. 5, the frame latches 108-1 and 108-2 are disengaged such that the frame member 104 and tailgate doors 102 may swing open about the horizontal axis 578.

Also as depicted in FIG. 5, the door latches 110-1 and 110-2 on the respective tailgate doors 102-1 and 102-2 are engaged with associated strike plates 470-1 and 470-2 on the frame member 104. In this configuration, the tailgate doors 102-1 and 102-2 are prevented from rotating about the respective vertical axes 474-1 and 474-2.

As described above, to swing the tailgate doors 102-1 and 102-2 down, a user may actuate at least one switch 118. As described above, the switches 118 may be of various types, including a single-pole mechanical switch, a capacitive switch, a pressure switch, or a piezoelectric switch, and may be integrated on either the tailgate doors 102-1 and 102-2 or a key fob. In either case, responsive to a receipt of a command from the switch 118, the controller 114 may activate the door latches 110-1 and 110-2, deactivate the frame latches 108-1 and 108-2, and activate the inter-door latch 112 to facilitate the opening and closing of the tailgate doors 102-1 and 102-2 about the horizontal axis 578.

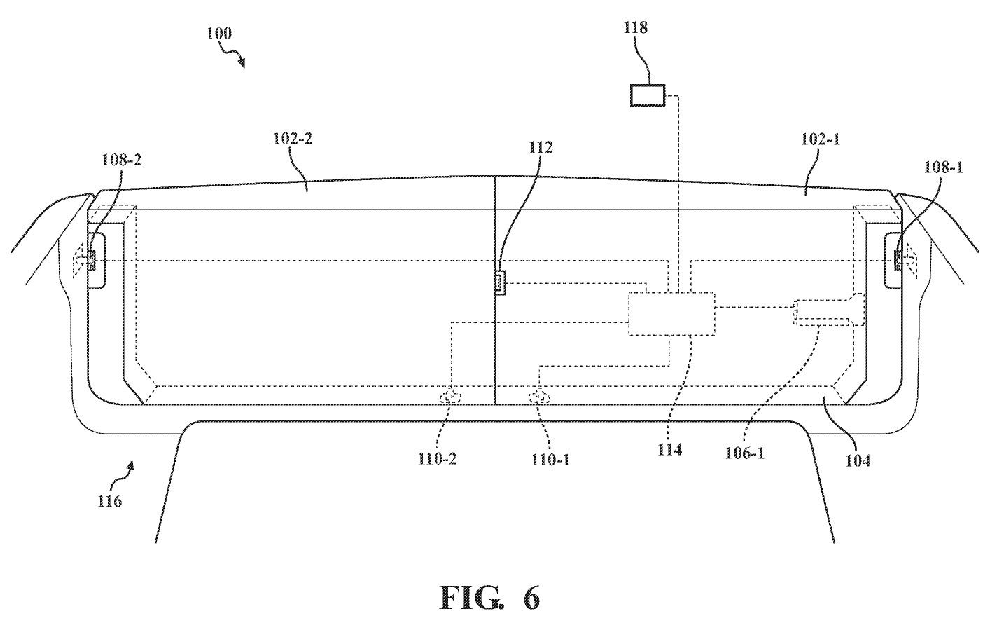

Note that while FIGS. 4 and 5 depict powered hinges 106-1 and 106-2 in both tailgate doors 102-1 and 102-2, it may be that just a first tailgate door 102-1 is controlled by a powered hinge 106-1. FIG. 6 depicts such an example, with a vehicle tailgate assembly 100 with two tailgate doors 102-1 and 102-2, one driven by a powered hinge 106-1, in a closed position. In this example, the second tailgate door 102-2 may be manually operated. The vehicle tailgate assembly 100 may include components previously described, such as a frame member 104 that extends horizontally under both the first tailgate door 102-1 and the second tailgate door 102-2 and vertically between each tailgate door 102-1 and 102-2 and the adjacent truck bed 116 sidewall, the first door latch 110-1, second door latch 110-2, the first frame latch 108-1, and the second frame latch 108-2. The vehicle tailgate assembly 100 may also include the inter-door latch 112 to couple the movement of the powered first tailgate door 102-1 and the non-powered second tailgate door 102-2 about the horizontal axis 578.

FIG. 7 illustrates one embodiment of a vehicle tailgate assembly 700 with a width-wide tailgate door 702, driven by a powered hinge 106, in a closed position. That is, in the example depicted in FIG. 7, the vehicle tailgate assembly 700 is a single-door assembly. Specifically, the vehicle tailgate assembly 700 includes a width-wide tailgate door 702 that extends across the entire width of the opening of the truck bed 116.

As depicted in FIG. 7, the width-wide tailgate door 702 may pivot about a vertical axis. However, the width-wide tailgate door 702, rather than being hingedly connected to the frame of the vehicle, is hingedly attached to a frame member 104, which, in this example, may be a single U-shaped frame member 104.

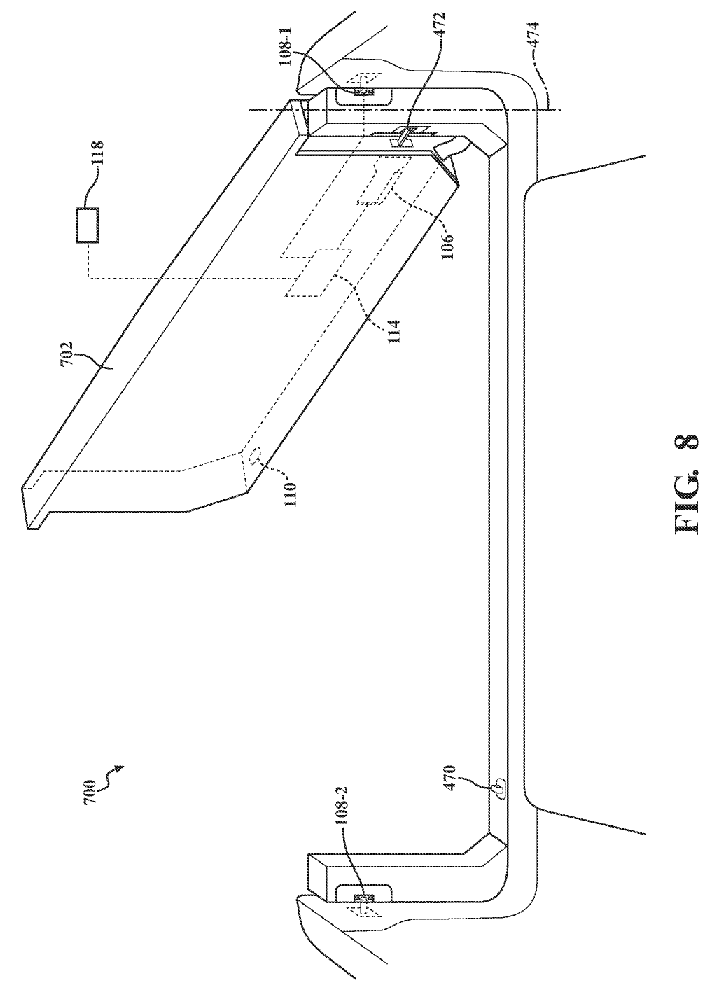

The portions of the frame member 104 that are to the side of the width-wide tailgate door 702 (i.e., the vertical portions of the frame member 104) may include frame latches 108-1 and 108-2 that interact with rods 576-1 and 576-2 on the vehicle frame to prevent the frame member 104 and width-wide tailgate door 702 from pivoting about the horizontal axis. That is, the frame member 104 may selectively pivot about a horizontal axis, as depicted in FIG. 8.

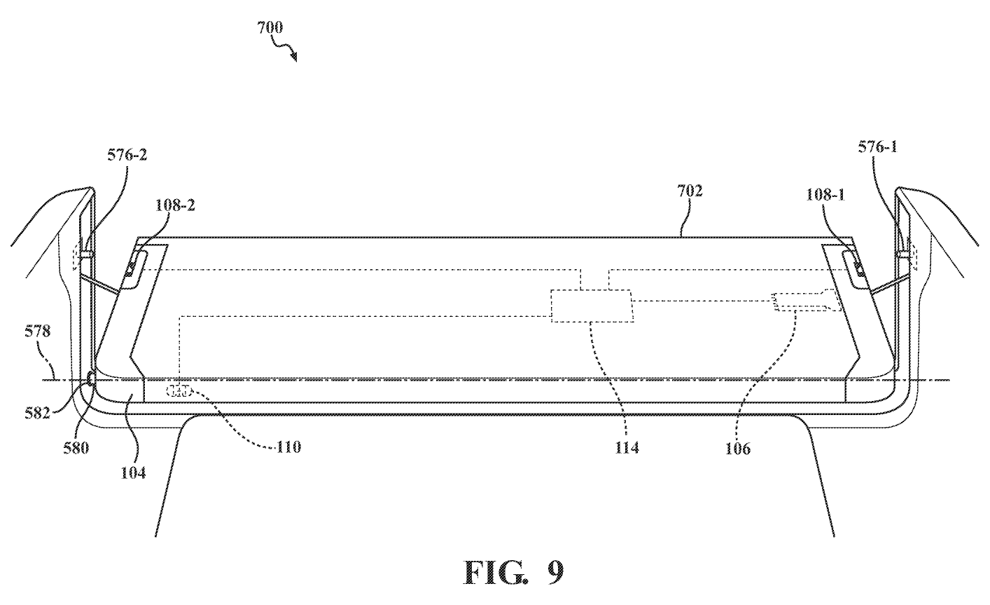

During some uses, for example, when the width-wide tailgate door 702 is to be swung out about the vertical axis as depicted in FIG. 8, the frame member 104 may be affixed to the frame of the vehicle via respective frame latches 108-1 and 108-2. FIG. 8 below depicts frame latches 108-1 and 108-2 engaged with the vehicle frame rods 576-1 and 576-2, and FIG. 9 below depicts frame latches 108-1 and 108-2 disengaged from the vehicle frame rods 576-1 and 576-2.

The portion of the frame member 104 that is below the width-wide tailgate door 702 (i.e., the horizontal portion of the frame member 104) may include a strike plate 470 that interacts with a single door latch 110 on the width-wide tailgate door 702 to prevent the width-wide tailgate door 702 from pivoting about the vertical axis. That is, one vertical portion of the frame member 104 may include a hinge 472 that allows rotational movement of the width-wide tailgate door 702 about a vertical axis. Note that in this example, a single door latch 110 instead of two may prevent the vertical axis pivot.

During some uses, for example, when the width-wide tailgate door 702 is to be swung downward about a horizontal axis as depicted in FIG. 9, the width-wide tailgate door 702 may be affixed to the frame member 104 via the door latches 110. FIG. 8 below depicts the door latch 110 disengaged with the frame member strike plate 470, and FIG. 9 below depicts the door latch 110 engaged with the frame member strike plate 470.

As described above, the width-wide tailgate door 702 may be heavy and cumbersome to swing open about the vertical axis. Moreover, a user’s hands/arms may not physically be free to manipulate the width-wide tailgate door 702. Accordingly, in this example, the vehicle tailgate assembly 700 includes a powered hinge 106 within the width-wide tailgate door 702 to articulate the width-wide tailgate door 702 about the vertical axis.

As described above, a first end 346 of the check arm 347 within the housing 220 is rigidly mounted within a width-wide tailgate door 702, and a second end 222 is pivotally coupled to the frame member 104. As the check arm 347 extends, it presses against the frame member 104. However, given that 1) the frame member 104 is immovable in the direction of the extension of the check arm 347 and 2) the width-wide tailgate door 702 is free to rotate, this force causes the width-wide tailgate door 702 to rotate outwards about the vertical axis.

Activation of the powered hinge 106 and the movement of the width-wide tailgate door 702 about the vertical axis may be controlled by a controller 114 as described above, with commands being received from switches 118 that may be mounted to the width-wide tailgate door 702 or on a key fob.

FIG. 8 illustrates one embodiment of a vehicle tailgate assembly 700 with one width-wide tailgate door 702, driven by a powered hinge 106, in an opened position. As described above, the powered hinge 106 is structured to articulate the width-wide tailgate door 702 through at least 85, and in some cases, greater than 90 degrees of rotational motion. This range of motion is accommodated by increasing the width of the opening 230 in the housing 220 of the powered hinge 106.

As described above, the width-wide tailgate door 702 may articulate about a vertical axis 474 and is attached to the frame member 104 via a hinge 472. Via this hinged attachment, the width-wide tailgate door 702 may rotate about a vertical axis between a closed position, as depicted in FIG. 7, and an open position, as depicted in FIG. 8.

FIG. 8 also depicts the arrangement of various other components of the vehicle tailgate assembly 700. Specifically, FIG. 8 depicts the strike plate 470 that interacts with the door latch 110 to either allow or prevent rotation of the width-wide tailgate door 702 about the vertical axis 474. As depicted in FIG. 8, the door latch 110 is disengaged, so the width-wide tailgate door 702 may swing open about the vertical axis.

Also as depicted in FIG. 8, the electromechanical frame latches 108-1 and 108-2 on the frame member 104 are engaged with associated rods 576-1 and 576-2 on the vehicle frame. In this arrangement, the frame member 104 and mounted width-wide tailgate door 702 are prevented from rotating about a horizontal axis.

FIG. 9 illustrates one embodiment of a vehicle tailgate assembly 700 with a single width-wide tailgate door 702 in a dropped position. In addition to swinging open about the vertical axis 474, the width-wide tailgate door 702 may pivot about a horizontal axis 578, as depicted in FIG. 9. Specifically, the frame member 104, and the attached width-wide tailgate door 702, may articulate about the horizontal axis 578. To facilitate this downward pivot motion, the frame member 104 may be attached to the frame of the vehicle in various ways, including a protrusion 580/socket 582 joint, as described above. Via this hinged attachment, the frame member 104 may rotate about the horizontal axis 578 between a closed position, as depicted in FIG. 7, and an open position, as depicted in FIG. 9.

FIG. 9 also depicts the arrangement of various other components of the vehicle tailgate assembly 700 to facilitate the pivoting about the horizontal axis 578. Specifically, FIG. 9 depicts the rods 576-1 and 576-2 that interact with respective frame latches 108-1 and 108-2 to either allow or prevent rotation of the frame member 104 about the horizontal axis 578. As depicted in FIG. 9, the frame latches 108-1 and 108-2 are disengaged, so the frame member 104 and width-wide tailgate door 702 may swing open about the horizontal axis 578.

Also as depicted in FIG. 9, the door latch 110 on the width-wide tailgate door 702 is engaged with the strike plate on the frame member 104. This configuration prevents the width-wide tailgate door 702 from rotating about the vertical axis 474.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

In this description, in one arrangement, the compartments of the vehicle include a passenger compartment, an engine compartment, a cargo area, and the like. Among other things, in one arrangement, the vehicle includes seats, a dash assembly, an instrument panel, controls, and the like housed in the passenger compartment. Additionally, in some instances, the vehicle may include an engine, a motor, a transmission, and the like, as well as other powertrain components, such as wheels, housed in the engine compartment and elsewhere in the vehicle. The wheels support the remainder of the vehicle on the ground. One, some or all of the wheels are powered by the remainder of the powertrain components to drive the vehicle along the ground.

Aspects herein can be embodied in other forms without departing from the spirit or essential attributes thereof. Accordingly, reference should be made to the following claims, rather than to the foregoing specification, as indicating the scope hereof.

1. A vehicle tailgate assembly, comprising:
a frame member, pivotally connected to a frame of a vehicle, that selectively pivots about a horizontal axis;
a first tailgate door, pivotally connected to the frame member, that selectively pivots about a vertical axis;
a first powered hinge, within the first tailgate door and pivotally coupled to the frame member, that articulates the first tailgate door about the vertical axis; and
a controller, electrically coupled to the first powered hinge, that activates the first powered hinge to articulate the first tailgate door.

2. The vehicle tailgate assembly of claim 1, wherein the first powered hinge articulates the first tailgate door through at least 85 degrees of rotational motion.

3. The vehicle tailgate assembly of claim 1, wherein the first powered hinge comprises:
a motor assembly;
a drive assembly coupled to the motor assembly, the drive assembly comprising:
a threaded spindle rotated by the motor assembly; and
a threaded nut surrounding and coaxial to the threaded spindle, the threaded nut translates along the threaded spindle as the threaded spindle rotates;
a check arm, pivotally connected at a first end to the threaded nut and pivotally connected at a second end to the frame member, the check arm articulates the first tailgate door about the vertical axis as the threaded nut translates along the threaded spindle; and
a gear assembly to transfer power from the motor assembly to the drive assembly.

4. The vehicle tailgate assembly of claim 3, further comprising a brake assembly to selectively lock the threaded spindle, the threaded nut, the check arm, and the first tailgate door in place.

5. The vehicle tailgate assembly of claim 4, wherein the brake assembly is an electromagnetic brake assembly.

6. The vehicle tailgate assembly of claim 1, further comprising:
frame latches to selectively couple the frame member to the frame of the vehicle; and
a first door latch to selectively couple the first tailgate door to the frame member.

7. The vehicle tailgate assembly of claim 1, wherein the first tailgate door extends across a first portion of a width of an opening of a truck bed.

8. The vehicle tailgate assembly of claim 7:
further comprising:
a second tailgate door, pivotally connected to the frame member, that selectively pivots about a second vertical axis, wherein a combined width of the first tailgate door and the second tailgate door spans the width of the opening of the truck bed; and
a second powered hinge, within the second tailgate door and coupled to the frame member, that articulates the second tailgate door about the second vertical axis; and
wherein the controller is electrically coupled to the second powered hinge and activates the second powered hinge to articulate the second tailgate door.

9. The vehicle tailgate assembly of claim 8, further comprising an inter-door latch that selectively couples the first tailgate door and the second tailgate door together.

10. The vehicle tailgate assembly of claim 1, further comprising at least one switch within the first tailgate door, the at least one switch controls operation of at least one of:
the first powered hinge;
a second powered hinge;
a first frame latch;
a second frame latch;
a first door latch;
a second door latch; and
an inter-door latch.

11. A vehicle tailgate assembly, comprising:
a frame member, pivotally connected to a frame of a vehicle, that selectively pivots about a horizontal axis;
a first tailgate door, pivotally connected to the frame member, that selectively pivots about a vertical axis;
a first powered hinge, within the first tailgate door and pivotally coupled to the frame member, that articulates the first tailgate door about the vertical axis through at least 85 degrees of rotational motion; and
a controller, electrically coupled to the first powered hinge, that activates the first powered hinge to articulate the first tailgate door.

12. The vehicle tailgate assembly of claim 11, wherein the first powered hinge comprises:
a motor assembly;
a drive assembly coupled to the motor assembly, the drive assembly comprising:
a threaded spindle rotated by the motor assembly; and
a threaded nut surrounding and coaxial to the threaded spindle, the threaded nut translates along the threaded spindle as the threaded spindle rotates;
a check arm, pivotally connected at a first end to the threaded nut and pivotally connected at a second end to the frame member, the check arm articulates the first tailgate door about the vertical axis as the threaded nut translates along the threaded spindle;
a gear assembly to transfer power from the motor assembly to the drive assembly; and
a brake assembly to selectively lock the threaded spindle, the threaded nut, the check arm, and the first tailgate door in place.

13. The vehicle tailgate assembly of claim 12, wherein the brake assembly is an electromagnetic brake assembly.

14. The vehicle tailgate assembly of claim 11, wherein the first powered hinge articulates the first tailgate door through at least 90 degrees of rotational motion.

15. The vehicle tailgate assembly of claim 11, further comprising:
frame latches to selectively couple the frame member to the frame of the vehicle; and
a first door latch to selectively couple the first tailgate door to the frame member.

16. The vehicle tailgate assembly of claim 11:
further comprising:
a second tailgate door, pivotally connected to the frame member, that selectively pivots about a second vertical axis, wherein a combined width of the first tailgate door and the second tailgate door spans a width of an opening of a truck bed;
a second powered hinge, within the second tailgate door and coupled to the frame member, that articulates the second tailgate door about the second vertical axis through at least 85 degrees of rotational motion; and
an inter-door latch that selectively couples the first tailgate door and the second tailgate door together; and
wherein the controller is electrically coupled to the second powered hinge and activates the second powered hinge to articulate the second tailgate door.

17. A vehicle tailgate assembly, comprising:
a frame member, pivotally connected to a frame of a vehicle, that selectively pivots about a horizontal axis;
a first tailgate door, pivotally connected to the frame member, that selectively pivots about a vertical axis;
a first powered hinge, within the first tailgate door and pivotally coupled to the frame member, that articulates the first tailgate door about the vertical axis, the first powered hinge comprises:
a motor assembly;
a drive assembly coupled to the motor assembly; and
a check arm translated by the drive assembly, translation of the check arm articulates the first tailgate door about the vertical axis; and
a controller, electrically coupled to the first powered hinge, that activates the first powered hinge to articulate the first tailgate door.

18. The vehicle tailgate assembly of claim 17, wherein the first powered hinge articulates the first tailgate door through at least 85 degrees of rotational motion.

19. The vehicle tailgate assembly of claim 17, further comprising:
frame latches to selectively couple the frame member to the frame of the vehicle; and
a first door latch to selectively couple the first tailgate door to the frame member.

20. The vehicle tailgate assembly of claim 17:
further comprising:
a second tailgate door, pivotally connected to the frame member, that selectively pivots about a second vertical axis, wherein a combined width of the first tailgate door and the second tailgate door spans a width of an opening of a truck bed;
a second powered hinge, within the second tailgate door and coupled to the frame member, that articulates the second tailgate door about the second vertical axis; and
an inter-door latch that selectively couples the first tailgate door and the second tailgate door together; and
wherein the controller is electrically coupled to the second powered hinge and activates the second powered hinge to articulate the second tailgate door.
